(19) United States
(12) Patent Application Publication
(10) Pub. No.: US 2012/0030738 A1
(43) Pub. Date: Feb. 2, 2012

(54) DIGITAL MEDIA CONTROLLER AND METHOD FOR SHARING MEDIA DATA BETWEEN NETWORKS USING THE DIGITAL MEDIA CONTROLLER

(75) Inventor: HUNG-CHANG LIN, Tu-Cheng (TW)

(73) Assignee: HON HAI PRECISION INDUSTRY CO., LTD., Tu-Cheng (TW)

(21) Appl. No.: 12/894,157

(22) Filed: Sep. 30, 2010

(30) Foreign Application Priority Data
Jul. 28, 2010 (CN) 201010239187.2

(51) Int. Cl. G06F 15/16; G06F 21/20

(52) U.S. Cl. 726/6; 709/205

(57) ABSTRACT

Digital media controller and a method for sharing media data include setting an account and a password. The method further includes when the second DMC sending input account and input password and logging on legally, searching and storing first shared media data in a first DMS into the shared folder and informing the second DMC to obtain a list of the first shared media data from the shared folder. The method further includes sending the first shared media data using a stream packet to the second DLNA network, in response that the first DLNA network receiving a request of accessing the first shared media data in the shared folder from the second DLNA network through a VPN.

### BACKGROUND

1. Technical Field

Embodiments of the present disclosure relate to a data sharing technology, and in particular, to a digital media controller and method for sharing media data between networks using the digital media controller.

2. Description of Related Art

Digital Living Network Alliance (DLNA) defines a standard for exchanging movies, photos, music, and other media data from one electronic device to another. An electronic device in a first DLNA may access media data in a second DLNA through a virtual private network (VPN). However, the media data in the second DLNA may be merely displayed on the electronic device. That is, the electronic device (e.g., a digital media player) in the first DLNA cannot obtain and play the media data in the second DLNA.

### BRIEF DESCRIPTION OF THE DRAWINGS

FIG. 1 is a block diagram of one embodiment of a digital media controller including a sharing system.

FIG. 2 is a block diagram of one embodiment of the sharing system of FIG. 1.

FIG. 3 is a flowchart of one embodiment of sharing media data between networks using the digital media controller, such as, for example, that of FIG. 1.

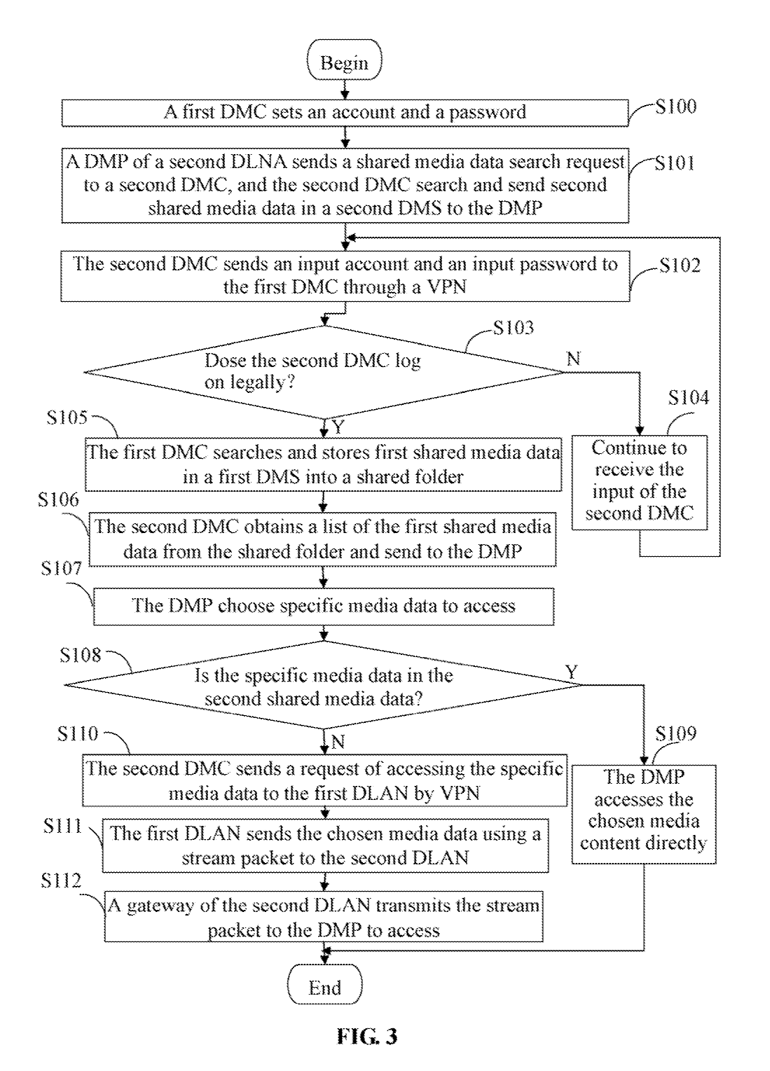

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage system.

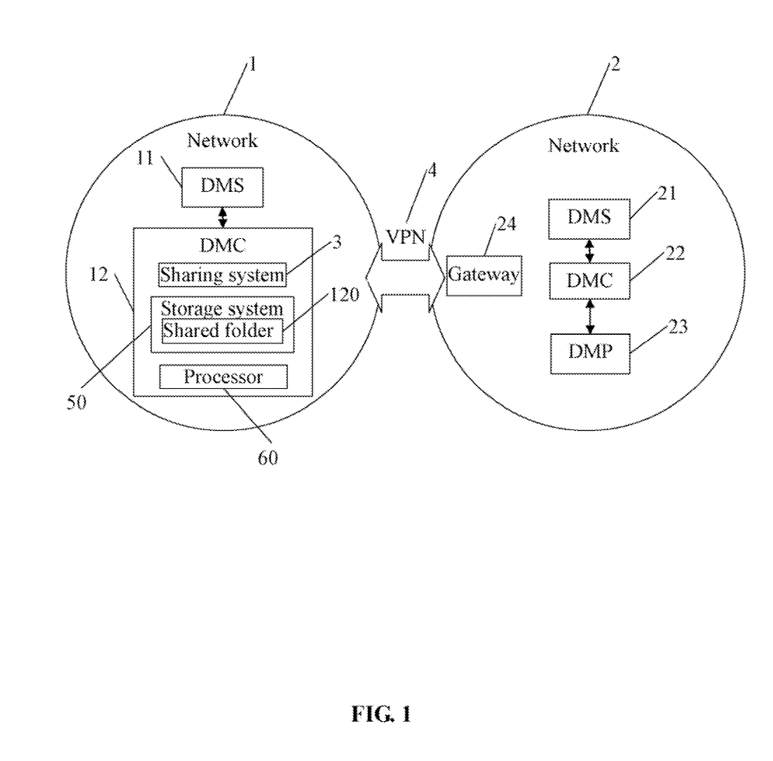

FIG. 1 is a block diagram of one embodiment of a digital media controller (DMC) 12 including a sharing system 3. The digital media controller 12 is in a Digital Living Network Alliance (DLNA) compliant network 1 (network 1 for simplification). The network 1 communicates with a DLNA compliant network 2 (network 2 for simplification) through a virtual private network (VPN) 4. The network 1 further includes a digital media server (DMS) 11. The network 2 includes a DMS 21, a DMC 22, a digital media player (DMP) 23 and a gateway 24. In some embodiments, the sharing system 3 may be used to share media data between the network 1 and the network 2.

The DMS 11 and the DMS 21 may be digital media servers (e.g., personal computers), that can provide media data, such as music, video, and photos, for example. In some embodiments, both the DMS 11 and the DMS 21 include shared media data (media available for sharing with others). The shared media data stored in the DMS 11 and the DMS 21 may be the same or different, for simplification, the DMS 11 stores first shared media data, and the DMS 21 stores second shared media data. The DMC 12 may be a PC or a VPN server, for example. The DMC 22 may be a PC or VPN client, for example.

The DMP 23 may be one or more audio or video (AV) devices, to access media data provided by the DMS 21. The DMP 23 may send a shared media data search request to the DMC 22, and then obtain search results from the DMC 22. The gateway 24 may receive and send requests and responses between networks, such as the network 1 and the network 2. In some embodiments, when the media data in network 1 is sent to the network 2, the gateway 24 may transmit the media data to the DMP 23 that needs to access the media data.

The DMC 12 further includes a storage system 50 that includes a shared folder 120. The shared folder 120 may authorize other DMCs (e.g. the DMC 22) with legally login to access data of the shared folder 120. The storage system 50 may be a memory of the DMC 12. The DMC 12 further includes a processor 60. The processor 60 executes one or more computerized code of the DMC 12 and other applications, to provide the functions of the DMC 12.

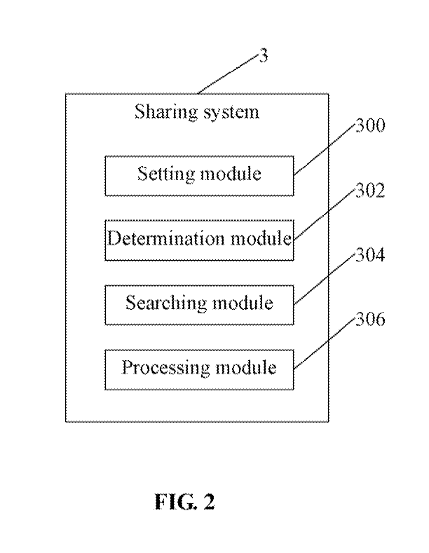

FIG. 2 is a block diagram of one embodiment of the sharing system 30 of FIG. 1. In some embodiments, the sharing system 30 includes a setting module 300, a determination module 302, a searching module 304, and a processing module 306. The modules 300, 302, 304 and 306 may comprise computerized code in the form of one or more programs that are stored in the storage system 50. The computerized code includes instructions that are executed by the at least one processor 60 to provide functions for modules 300, 302, 304 and 306. Details of these operations follow.

The setting module 300 is used to set an account and a password of the DMC 12, to control access by other DMCs to the DMC 12. In some embodiments, when the DMP 23 sends the shared media data search request to the DMC 22, the DMC 22 searches for the second shared media data in the DMS 21 and, if found, sends the second shared media data in the DMS 21 to the DMP 23. Simultaneously, the DMC 22 sends an input account and input password to trigger the DMC 12 to search for first shared media data in the DMS 11.

The determination module 302 determines whether the DMC 22 has access rights by comparing the input account and the input password input from the DMC 22 with the set account and the set password of the DMC 12. If the input account and the input password match, the determination module 302 determines that the DMC 22 logs on legally. If either of the input account and the input password is different from the set account and the set password, the determination module 302 determines that the DMC 22 logs on illegally and is denied access.

When the DMC 22 logs on legally, the searching module 304 searches for the first shared media data in DMS 11 and stores the first shared media data in the shared folder 120.

When the DMC 22 logs on illegally, the processing module 306 prompts that the input account or the input password is wrong, and then waits for the input again.

The processing module 306 further informs the DMC 22 to obtain a list of the first shared media data from the shared folder 120. In some embodiments, the DMC 22 may obtain the list of the first shared media data from the shared folder 120, and sends the list of the first shared media data to the DMP 23. The DMP 23 includes the list of the first shared media data in the network 1 and the second shared media data in the network 2. The DMP 23 chooses specific media data from the first shared media data and the second shared media data to access. The DMC 22 may determine whether the specific media data is in the second shared media data in the network 2 or in the second shared media data in the network 1. If the specific media data is in the second shared media data, the DMP 23 accesses the specific media data directly. If the specific media data is in the first shared media data, the DMC 22 sends the request of accessing the specific media data in the shared folder 120 through the VPN 4 to the network 1.

When the network 1 receives the request of the specific media data in the shared folder 120, the processing module 306 further sends specific media data using a stream packet to the network 2. The gateway 24 may transmit the stream packet to DMP 23. Thus, the network 1 and the network 2 may share media data with each other.

FIG. 4 is a flowchart of one embodiment of a method for sharing media data in digital media controller. Depending on the embodiment, additional blocks may be added, others removed, and the ordering of the blocks may be changed.

In block S100, the setting module 300 sets an account and a password for the DMC 12, to control access by other DMCs to the DMC 12.

In block S101, when the DMP 23 sending shared media data search request to the DMC 22, the DMC 22 searches for the second shared media data in the DMS 21 and sends the second shared media data to the DMP 23.

In block S102, the DMC 22 sends input account and input password to connect the DMC 21 in network 1 by VPN 4, to trigger the DMC 12 searching for the first shared media data in the DMS 11.

In block S103, the determination module 302 determines whether the DMC 22 has access rights by comparing the input account and the input password input from the DMC 22 with the set account and the password of the DMC 12.

When the DMC 22 logs on illegally, in block S104, the processing module 306 prompts that the input account and input password is wrong, and continue receives another input account and input password from the DMC 22, then the procedure turns to the block S102.

When the DMC 22 logs on legally, in block S105, the searching module 304 searches for the first shared media data in DMS 11 and stores the first shared media data into the shared folder 120.

In block S106, the processing module 306 further informs the DMC 22 obtaining a list of the first shared media data from the shared folder 120. The DMC 22 obtains the list of the first shared media data from the shared folder 120, and sends the list of the first shared media data to the DMP 23.

In block S107, the DMP 23 chooses specific media data from the first shared media data and the second shared media data to access.

In block S108, the DMC 22 determines whether the specific media data is in the first shared media data in the network 1 or in the second shared media data in the network 2.

When the specific media data is in the second shared media data, in block S109, the DMP 23 accesses the specific media data directly.

When the specific media data is not in the second shared media data, in block S110, the DMC 22 sends a request of accessing the specific media data in the shared folder 120 by VPN 4 to the network 1.

In block S111, the processing module 306 sends specific media data in the shared folder 12 using a stream packet to the network 2.

In block S112, the gateway 24 transmits the stream packet to DMP 23 to access.

It should be emphasized that the described inventive embodiments are merely possible examples of implementations, and set forth for a clear understanding of the principles of the present disclosure. Many variations and modifications may be made to the-described inventive embodiments without departing substantially from the spirit and principles of the present disclosure. All such modifications and variations are intended to be comprised herein within the scope of this disclosure and the-described inventive embodiments, and the present disclosure is protected by the following claims.

What is claimed is:

1. A computer-implemented method for sharing media data between a first digital living network alliance (DLNA) network and a second DLNA network, the first DLNA network in communication with the second DLNA network through a virtual private network (VPN), the method comprising:
(a) searching first shared media data in a first digital media server (DMS) of the first DLNA network, and storing the first shared media data into a shared folder in a first digital media controller (DMC) of the first DLNA network;
(b) informing a second DMC of the second DLNA network to obtain a list of the first shared media data from the shared folder;
(c) in response that the first DLNA network receives a request of accessing the first shared media data from the second DLNA network through the VPN, sending the first shared media data using a stream packet to the second DLNA network.

2. The method as claimed in claim 1, before step (a) further comprising:
setting an account and a password for the first DMC; and
determining whether the second DMC logs on legally by comparing an input account and an input password input from the second DMC with the set account and the password.

3. The method as claimed in claim 2, further comprising:
prompting that the input account or the input password is wrong and continuing receiving the input account and input password from the second DMC, if the second DMC logs on illegally.

4. The method as claimed in claim 2, further comprising:
in response to receiving a shared media data search request from a digital media player (DMP) in the second DLNA network, sending the input account and the input password to the first DLNA network to trigger the first DMC to search the first shared media data in the first DMS by the second DMC; and
searching second shared media data in a second DMS of the second DLNA network, and sending the second shared media data to the DMP by the second DMC.

5. The method as claimed in claim 4, between step (b) and step (c), the method further comprising:
choosing specific media data to access by the DMP;
determining whether the specific media data is in the first shared media data or in the second shared media data; and
accessing the specific media data if the specific media data is in the second shared media data; or
sending a request of accessing the specific media data through the VPN to the first DLNA network if the specific media data is in the first shared media data.

6. The method as claimed in claim 1, further comprising:
transmitting the stream packet to the DMP in the second DLNA network through a gateway in the second DLNA network.

7. A storage medium storing a set of instructions, the set of instructions capable of executed by a processor to perform a method for sharing media data between a first digital living network alliance (DLNA network) and a second DLNA network, the first DLNA network in communication with the second DLNA network through a virtual private network (VPN), the method comprising:
(a) searching first shared media data in a first digital media server (DMS) of the first DLNA network, and storing the first shared media data into a shared folder in a first digital media controller (DMC) of the first DLNA network;
(b) informing a second DMC of the second DLNA network to obtain a list of the first shared media data from the shared folder;
(c) in response that the first DLNA network receives a request of accessing the first shared media data from the second DLNA network through the VPN, sending the first shared media data using a stream packet to the second DLNA network.

8. The storage medium as claimed in claim 7, before step (a), further comprising:
setting an account and a password for the first DMC; and
determining whether the second DMC logs on legally by comparing an input account and an input password input from the second DMC with the set account and the password.

9. The storage medium as claimed in claim 8, further comprising:
prompting that the input account or the input password is wrong and continuing receiving the input account and input password from the second DMC, if the second DMC logs on illegally.

10. The storage medium as claimed in claim 8, further comprising:
in response to receiving a shared media data search request from a digital media player (DMP) in the second DLNA network, sending the input account and the input password to the first DLNA network to trigger the first DMC to search first shared media data in the first DMS by the second DMC; and
searching second shared media data in a second DMS of the second DLNA network and sending the second shared media data to the DMP by the second DMC.

11. The storage medium as claimed in claim 10, between step (b) and step (c), further comprising:
choosing specific media data to access by the DMP;
determining whether the specific media data is in the first shared media data or in the second shared media data; and
accessing the specific media data if the specific media data is in the second shared media data; or
sending a request of accessing the specific media data in the shared folder through the VPN to the first DLNA network, if the specific media data is in the first shared media data.

12. The storage medium as claimed in claim 7, further comprising:
transmitting the stream packet to the DMP in the second DLNA network through a gateway in the second DLNA network.

13. A digital media controller (DMC) in a first digital living network alliance (DLNA network), the first DLNA network communicating with a second DLNA network by a virtual private network (VPN), comprising:
a storage system to store a shared folder;
at least one processor; and
one or more programs stored in the storage system, executable by the at least one processor, the one or more programs comprising:
a searching module operable to search first shared media data in a first digital media server (DMS) of the first DLNA network, and storing the first shared media data into the shared folder;
a processing module operable to inform a second DMC of the second DLNA network to obtain a list of the first shared media data from the shared folder;
the processing module further operable to send the first shared media data using a stream packet to the second DLNA network, in response that the first DLNA network receives a request of accessing the first shared media data from the second DLNA network through the VPN.

14. The digital media controller as claimed in claim 13, wherein the one or more programs further comprising:
a setting module operable to set an account and a password;
a determination module operable to determine whether the second DMC logs on legally by comparing an input account and an input password input from the second DMC with the set account and the password.

15. The digital media controller as claimed in claim 14, wherein the processing module further operable to prompt that the input account or the input password is wrong, and continuing receiving the input account and input password from the second DMC, if the second DMC logs on illegally.

16. The digital media controller as claimed in claim 14, wherein a digital media player (DMP) in the second DLNA network operable to send a shared media data search request to the second DMC; and
the second DMC operable to send the input account and the input password to the first DLNA network, to trigger the first DMC searching first shared media data in the first DMS;
the second DMC further operable to search and send second shared media data in a DMS of the second DLNA network to the DMP.

17. The digital media controller as claimed in claim 16, wherein the second DMC further operable to determine whether a specific media data chosen by the DMP is in the second shared media data; and
access the specific media data if the specific media data is in the second shared media data; or
send a request of accessing the specific media data in the shared folder through the VPN to the first DLNA network if the specific media data is in the first shared media data.

18. The digital media controller as claimed in claim 13, wherein the second DLNA network comprises a gateway operable to transmit the stream packet to the DMP in the second DLNA network.
